(19) United States
(12) Patent Application Publication
(10) Pub. No.: US 2026/0170784 A1
(43) Pub. Date: Jun. 18, 2026

(54) ADAPTIVE CHARACTERISTIC FOR VIRTUAL CONTENT BASED ON SURFACE DEPTH

(71) Applicant: GOOGLE LLC, Mountain View, CA (US)

(72) Inventors: Björn Nicolaas Servatius Vlaskamp, Seattle, WA (US); Hagar Adler, Seattle, WA (US)

(21) Appl. No.: 19/423,535

(22) Filed: Dec. 17, 2025

Related U.S. Application Data
(60) Provisional application No. 63/735,609, filed on Dec. 18, 2024.

(51) Int. Cl. G06T 19/20; G06F 3/01

(52) U.S. Cl. CPC G06T 19/20; G06F 3/013; G06T 2219/2012

(57) ABSTRACT

Systems, methods, and apparatuses for determining and/or modifying a characteristic such as the color of virtual content in a display device are disclosed. For example, an illustrative method includes determining a characteristic based on a first distance from a display device to a focal plane for virtual content and a second distance from the display device to a surface visible in a region of the field of view associated with the virtual content. This characteristic may be, for instance, a color for the virtual content. The display device then displays the virtual content at the focal plane with the characteristic (e.g., the determined color). This determination can align an apparent focal distance of the virtual content with a user's point of accommodation, thereby improving visual comfort. Corresponding apparatuses, methods, and non-transitory computer-readable media are also described.

### CROSS REFERENCE TO RELATED APPLICATION

This application claims the benefit of U.S. Provisional Application No. 63/735,609, filed Dec. 18, 2024, the disclosure of which is incorporated herein by reference in its entirety.

### BACKGROUND

Extended reality (XR) devices, such as virtual reality (VR) headsets and augmented reality (AR) glasses, are increasingly utilized in various applications to provide users with immersive digital experiences. Many such devices, particularly in the AR space, include see-through displays and associated optical elements, such as waveguides and lenses, that are configured to combine a user's view of a real-world environment with computer-generated virtual content. A primary goal in the design of such devices is to present the virtual content in a manner that is clear, stable, and comfortable for a user to view, even during prolonged use. The quality of the optical systems and the methods used to render content on the displays can significantly impact a user's experience and the overall effectiveness of the device in seamlessly blending virtual and real-world views.

### SUMMARY

Systems and methods are disclosed herein for determining a characteristic such as color for virtual content presented by an extended reality (XR) device. A technical problem can arise in see-through XR devices where virtual content is presented at a fixed focal distance, while a user may be viewing the content overlaid on real-world surfaces at various other distances. This mismatch can require the user to constantly re-accommodate (i.e., exert effort to refocus) their eyes when shifting their gaze, which can lead to visual fatigue and discomfort. To address this, technical solutions described herein determine a characteristic based on the fixed focal distance and a measured distance to a real-world surface that is to be overlaid by the virtual content. For instance, this characteristic may be a color for the virtual content (e.g., a color composition, etc.). A color characteristic determined in this way may be selected to adjust the perceived focal distance of the virtual content, making it appear sharper and clearer to a user who is focused on a real-world surface at a different distance. As a technical effect, this improves visual comfort in a computationally efficient manner without requiring complex, variable-focus optical hardware.

In some aspects, the techniques described herein relate to a method including: determining a characteristic for virtual content to be displayed by a display device within a field of view of the display device, the characteristic being determined based on: a first distance from the display device to a focal plane for the virtual content, and a second distance from the display device to a surface visible in a region of the field of view associated with the virtual content; and displaying, by the display device, the virtual content at the focal plane with the characteristic.

In some aspects, the techniques described herein relate to an apparatus including: a plurality of emitters configured to generate light representing virtual content; a waveguide configured to manipulate the light generated by the plurality of emitters to display the virtual content at a focal plane a first distance from the apparatus; and a controller configured to: determine a characteristic based on the first distance and based on a second distance from the apparatus to a surface visible in a region of a field of view associated with the virtual content; and control the plurality of emitters to display the virtual content at the focal plane with the characteristic.

In some aspects, the techniques described herein relate to a non-transitory computer-readable medium storing instructions that, when executed, cause a controller of a display device to perform a process including: determining a characteristic for virtual content to be displayed by the display device within a field of view of the display device, the characteristic being determined based on: a first distance from the display device to a focal plane for the virtual content, and a second distance from the display device to a surface visible in a region of the field of view associated with the virtual content; and causing the display device to display the virtual content at the focal plane with the characteristic.

Various implementations, such as methods, systems, and computer-readable media, are disclosed herein. It will be understood that these various implementations are not mutually exclusive. For example, operations described in the context of a method may be performed by a suitably configured system, and a system may be configured to perform operations described as part of a method. Similarly, instructions stored on a computer-readable medium may cause a system to perform a disclosed method. Further details of these and other implementations are set forth in the accompanying drawings and the description below.

### BRIEF DESCRIPTION OF THE DRAWINGS

FIG. 1 shows an illustrative implementation of adaptive color determination for virtual content based on surface depth in accordance with principles described herein.

FIG. 2 shows a flowchart for an illustrative method implementing adaptive color determination for virtual content based on surface depth in accordance with principles described herein.

FIG. 3 shows a block diagram of an illustrative display device configured for adaptive color determination for virtual content based on surface depth in accordance with principles described herein.

FIG. 4 shows an illustrative environment for implementing adaptive color determination for virtual content based on surface depth in accordance with principles described herein.

FIG. 5A shows aspects of an illustrative technique for determining a surface depth for adaptive color determination in accordance with principles described herein.

FIG. 5B shows aspects of another illustrative technique for determining a surface depth for adaptive color determination in accordance with principles described herein.

FIG. 6 shows a first illustrative scenario related to adaptive color determination for virtual content based on surface depth in accordance with principles described herein.

FIG. 7 shows a second illustrative scenario related to adaptive color determination for virtual content based on surface depth in accordance with principles described herein.

FIG. 8 shows a third illustrative scenario related to adaptive color determination for virtual content based on surface depth in accordance with principles described herein.

FIG. 9 shows further illustrative scenarios for implementing adaptive color determination for virtual content in accordance with principles described herein.

FIG. 10 shows a block diagram of an illustrative computing system for implementing adaptive color determination for virtual content based on surface depth in accordance with principles described herein.

### DETAILED DESCRIPTION

The technology described herein relates to a solution to a common physical problem with AR glasses: eye strain. This problem occurs because the virtual information displayed by the glasses is at a fixed focus distance (e.g., six feet away), but the real world is not. When a user tries to view a virtual notification overlaid on a nearby physical object, like a phone screen, their eyes are forced to rapidly and repeatedly refocus, which is tiring. The described solution leverages the fact that the human eye naturally focuses different colors at different depths. By detecting the distance to the real-world surface a user is looking at, the system can intelligently shift the color of the virtual content—making it more reddish for near objects and more bluish for far objects—to make it appear sharp at the correct depth. This simple color adjustment significantly improves visual comfort without needing complex, expensive, or power-hungry moving lenses.

More specifically, extended reality (XR) devices, such as smart glasses, and other types of devices using see-through displays may be configured to overlay virtual content (e.g., computer-generated content) onto a user's view of the real world. A technical challenge with these devices arises, however, when that virtual content is presented at a single, fixed focus distance (e.g., appearing to be six feet away), while real-world objects visible through the display are at various distances. When a user tries to view virtual information on a nearby object (e.g., reading a virtual translation on a physical menu held a few inches from their eyes), their eyes must constantly work to refocus between the close-up surface (e.g., the menu, in this example) and the farther-away virtual text. This can cause eye strain and visual fatigue. In addition, this depth mismatch can be visually disorienting, as the human brain expects a nearby object (like the menu) to occlude, or block, more distant content (like the virtual text). To address these issues, technical solutions described herein intelligently adjust the color of the virtual content based on the distance to the real-world surface it overlays. By shifting the content's color more towards red when overlaid on a near surface, or more toward blue for a far surface, these technical solutions leverage a natural property of the human eye to shift the perceived focus of the content. This allows the virtual information to appear sharp and clear without requiring the user to constantly re-accommodate (i.e., refocus) their eyes.

The technological context of implementations described herein, as well as various technical problems they address, technical solutions they propose, and technical benefits they provide, will now be described in more detail.

Systems and methods described herein are situated in the general technological field of extended reality (XR) devices (which include augmented reality (AR) and virtual reality (VR) systems) and possibly other types of device with see-through displays (and optical see-through (OST) displays, in particular). For example, illustrative implementations relate to see-through display devices such as AR glasses, which may be configured to blend computer-generated virtual content with a user's view of their real-world environment. To achieve this, such devices typically incorporate a set of core components, including one or more display panels (e.g., micro light-emitting diode (microLED) panels), and one or more optical elements (e.g., waveguides, lenses, etc.) positioned to direct light from the display panels toward a user's eyes. These optical elements may be configured to form a virtual image of the content that appears stable and is viewable at a comfortable distance.

A significant technical problem arises in the design and operation of these see-through display devices from a fundamental mismatch between the device's optics and the natural function of the human visual system. The optical elements of a typical AR device may be designed to present virtual content at a single, fixed focal plane, causing the virtual content to appear at a fixed distance from the user (e.g., two meters away). However, in a real-world environment, a user's attention may constantly shift between objects at a wide variety of distances, from a handheld object at 30 centimeters to a person across the room at four meters. When virtual content is intended to overlay or be associated with a real-world object, a discrepancy between the fixed focal distance of the virtual content and the actual distance of the real-world object can occur.

This discrepancy forces the user's visual system to exert constant effort to resolve conflicting depth cues. The human visual system uses a variety of physiological actions to perceive depth and maintain focus. One of these actions is referred to as accommodation, which is the process by which the ciliary muscles in the eye contract or relax to change the shape of the eye's lens, thereby adjusting its focal power to bring an object at a certain distance into sharp focus on the retina. Other such actions that help the eye to perceive depth could include an assessment of blur at a particular accommodation level, the amount of vergence (the process by which both eyes rotate inward by a certain amount to align their gaze on an object) needed to focus on a particular object, and so forth.

The technical problem of accommodation fatigue becomes particularly acute in these AR devices. If a user wearing an AR device with a focal plane fixed at two meters looks at a physical menu held at 30 centimeters, their accommodative system adjusts the eye's lens to bring the nearby menu into focus. However, to see the virtual content overlaid on that menu, the eye must then try to re-accommodate for the two-meter distance of the focal plane. This requirement to constantly and rapidly re-accommodate when shifting gaze between the real-world surface and the virtual overlay places significant strain on the eye's ciliary muscles. This sustained effort can lead to significant visual fatigue, eye strain, headaches, and general discomfort, degrading the user experience. Furthermore, this depth mismatch can be visually disorienting, as the human brain expects a nearby object to occlude, or block, more distant content. When virtual content that appears to be two meters away is not blocked by a menu held at 30 centimeters, it can break the user's sense of immersion.

This technical problem is exacerbated in certain types of devices, particularly monocular AR devices that present virtual content to only one of the user's eyes. While a binocular system can leverage stereoscopic rendering to create some illusion of depth for virtual objects, a monocular system lacks these binocular vergence cues. As a result, the fixed nature of the focal plane may be more apparent in a monocular device, and the burden of resolving the depth mismatch falls almost entirely on the viewer's accommodation of the content and related phenomena such as the blur that is perceived.

Conventional solutions for addressing this technical problem have generally focused on complex hardware-based approaches, which introduce significant drawbacks of their own. One conventional solution involves implementing variable-focus optics, such as mechanical systems with physically moving lenses (varifocal systems) or liquid crystal lenses that can be electronically switched between a few discrete focal planes (multifocal systems). While theoretically capable of adjusting the focal plane to match the user's point of gaze, these systems are often bulky, heavy, expensive, slow to respond, and power hungry. These characteristics tend to be contrary to design goals of creating XR devices that are lightweight, power-efficient, and can be worn comfortably all day.

To overcome the limitations of these conventional hardware-based approaches, technical solutions described herein provide a computationally efficient, software-based method for mitigating accommodation-related eye strain. These technical solutions are based on leveraging a natural and inherent optical property of the human eye itself: longitudinal chromatic aberration (LCA). As will be further described and illustrated below, the eye's lens does not focus all wavelengths (i.e., colors) of light onto the exact same plane. Due to the refractive properties of the lens, shorter wavelengths like blue light are bent more sharply and converge at a focal point closer to the lens, while longer wavelengths like red light are bent less and converge at a focal point farther away. The total focal range between the extremes of the visible spectrum can be as large as 1.5 to 2.0 diopters. The human visual system is constantly exposed to this phenomenon and even uses it as a subconscious directional cue to guide the accommodation process. Implementations described herein therefore use this natural optical effect to adjust an apparent focal distance of virtual content without physically altering the device's optics.

While the determining of a characteristic such as the color for the virtual content may be performed directly based on the first and second distances, in some implementations this may be performed as a two-step process. In such implementations, a controller may first determine a parameter based on a relationship between the first distance and the second distance (e.g., a difference, a ratio, etc.), and then use that parameter as an input to an algorithm that determines the final characteristic (e.g., the color composition) for the virtual content.

Technical solutions described herein involve a novel process in which a display device first determines the distance to a real-world surface that is to be at least partially overlaid by virtual content. The device then determines a color for the virtual content based on a parameter that relates this measured surface distance to the device's fixed focal distance. Specifically, if the real-world surface is closer than the focal plane, the device determines a color for the virtual content that is shifted toward longer wavelengths (i.e., is made more reddish). This leverages the naturally longer focal length of red light, making the virtual content appear sharp to an eye that is accommodated for a near distance. Conversely, if the real-world surface is farther than the focal plane, the device determines a color for the virtual content that is shifted toward shorter wavelengths (i.e., is made more bluish). This leverages the naturally shorter focal length of blue light, making the content appear sharp to an eye that is accommodated for a far distance.

To implement these technical solutions, the display device must first determine the distance to the relevant real-world surface. This can be accomplished through several techniques. In some implementations, an outward-facing depth sensor, such as a time-of-flight (ToF) sensor or a stereo camera pair, may be used to generate a depth map of the environment. A controller can then identify the distance to the specific surface (within the environment and visible in the current field of view of the device) that the virtual content is intended to overlay. This approach is powerful as it can be implemented based on occlusion cues without necessarily needing to track the user's specific point of gaze. In certain implementations (e.g., those with binocular see-through displays), a binocular eye-tracking system may be used to determine the user's point of focus and/or to calculate the vergence angle of the eyes, which may then be used to infer the distance to the object of focus.

Technical solutions described herein provide a variety of advantageous technical effects. A primary technical effect is a significant improvement in user comfort. By digitally aligning the apparent focal point of the virtual content with the user's natural accommodation state, the system directly mitigates the need for constant, fatiguing re-accommodation. This makes the device more comfortable to use for extended periods. Another technical effect is the solutions'high computational efficiency. The process of determining a color shift is a lightweight computational task compared to conventional solutions like real-time ray tracing or dynamic optical adjustment, making it ideally suited for the constrained processing and power budgets of mobile, battery-powered AR devices.

A further, significant technical effect in certain implementations relates to the potential for hardware simplification and cost reduction. Many AR devices natively rely on a “push-pull” optical system that works by putting the native focus of the content at infinity, using a “pull” lens to bring the virtual content from infinity to the desired fixed focal distance (e.g., two meters), and using a second “push” lens coupled with the pull lens to cancel out the optical power of the first lens for the real-world view (keeping the real world undistorted, since it is also affected by the pull lens). In many implementations, technical solutions described herein may be used in combination with the push-pull system. However, in certain implementations, it could be desirable to simplify the potentially significant hardware complexity, cost, and weight that the push-pull system adds to the device. Moreover, the precise alignment and manufacturing tolerances required for these lenses can also lead to lower production yields and introduce other optical artifacts, which may provide more motivation to reduce or eliminate the need for the push-pull system in certain implementations.

Thus, given the technical effect of solutions described herein to manage the apparent focal distance of virtual content in software, these solutions could, in certain implementations, have the further technical effect of enabling the complete removal of (or at least significant simplification of) the push-pull lens system and/or other complex and costly hardware. Eliminating these optical components can lead to a display device that is lighter, thinner, less complex, and cheaper to manufacture, with improved production yields. This may allow for a more robust hardware design and can also support a larger diopter range for users who require vision correction.

An additional technical effect relates to power efficiency, particularly in devices that utilize displays with per-channel color control, such as microLED displays. As will be further described and illustrated below, certain directional color shifts can be implemented by selectively deactivating entire sets of emitters. For example, to achieve a strong red-shift, the controller can completely turn off the blue emitters, and vice versa. Since power is only consumed by active emitters in a microLED display, this act of deactivating a color channel may directly reduce the overall power consumption of the device, providing a dual benefit of improved visual comfort and increased battery life.

Certain terminology used in this description may be understood in the following sense to aid in describing principles set forth herein. These definitions are provided as examples and are not intended to be limiting; they may be added to and/or further defined and clarified by the examples described herein.

As used herein, a “display device” or “apparatus” may refer to an electronic system configured to present visual information to a user. Such a device may be implemented as a head-mounted extended reality (XR) device, such as augmented reality (AR) glasses or a virtual reality (VR) headset. “Virtual content” may refer to any computer-generated visual information, such as text, images, animations, or graphical user interface elements, that is intended to be displayed by a display device. As used herein, a “surface” may refer to a boundary of a real-world object within an environment that is visible to a user or detectable by a sensor of a display device. A surface may be planar, such as a wall, or may have a complex, non-planar geometry, such as the surface of a person's face or an irregularly shaped piece of machinery.

In implementations described herein, a surface may be located within a “region” of the field of view associated with the virtual content. This region refers to the specific area within the display's overall field of view where the virtual content is intended to be presented. This region is therefore associated with the virtual content in that it is the designated location for that content. A surface visible within this region is thus a surface that the virtual content is intended to appear in front of. In other words, a surface visible within a region of the field of view associated with the virtual content will be understood to be a surface that is to be at least partially overlaid by the virtual content from the user's perspective.

A “focal plane” may refer to a plane in space at which an optical system is configured to form a sharp virtual image of content. For many XR devices described herein, the focal plane may be at a fixed distance from the display device. As used herein, a “characteristic” for virtual content may refer to any visual property of the content that can be modified to influence a user's accommodation. The primary example of such a characteristic, as described extensively herein, is the color of the virtual content (e.g., its spectral composition, also referred to as “color composition”). Other examples of a characteristic that may be modified in some implementations include, without limitation, a blur, a contrast, or a spatial frequency of the virtual content. As used herein, “distance” may refer to a measurement of separation between two points, planes, or objects. The term may refer to a direct line-of-sight measurement from a component of a display device (e.g., a sensor) to a surface, or it may be a calculated or effective distance that accounts for various offsets, such as the distance from a user's eye to the surface, which may be derived from sensor data and known device geometry. For a complex or non-planar surface, the distance may be an average, minimum, or otherwise representative distance to the portion of the surface being overlaid by virtual content. A “parameter” may refer to a value or set of values determined by a controller that is based on a relationship between two or more inputs, such as a first distance and a second distance. A parameter may be a simple difference, a ratio, a diopter value, or a scaled value used as an input for a subsequent process, such as a color determination algorithm.

In some implementations, a parameter used in the determination of a characteristic such as the color of virtual content may also refer to an intermediate value calculated by a controller that quantifies the relationship between a device's optical properties and a real-world environmental measurement, which is then used to govern a subsequent rendering operation. In some implementations, a parameter may be a numerical value or data structure that represents the magnitude of a focal mismatch between a virtual focal plane and a physical surface, the parameter serving as a direct input to a color adjustment model. In some implementations, a parameter may refer to any value derived from processing two or more distance measurements, which serves to translate a spatial relationship into a value that can be mapped to a specific adjustment in the spectral properties of virtual content.

As used herein, a “color” for virtual content may refer to the specific spectral composition of light that is to be emitted by the display device to represent that virtual content. A “spectral property” may refer to a characteristic of light related to its distribution of energy across different wavelengths. As such, determining or modifying a color or spectral property may include defining or changing the relative intensity of different wavelengths, such as shifting a default color toward longer or shorter wavelengths. A “nominal color” or “default color” may refer to an intended or original color of virtual content before any color modification is applied. A “white point” may refer to a reference color in a color space that is defined as “white”; shifting a white point to be “warmer” or “cooler” affects the overall color cast of the content. A “primary color” may refer to one of a set of fundamental colors (e.g., red, green, and blue in an RGB system) that can be combined to produce a gamut of other colors. “Monochrome text” may refer to textual content that is rendered using a single color (e.g., a single spectral composition and not necessarily a single primary color) against a background.

As used herein, a “depth sensor” may refer to a hardware component configured to measure the distance to objects and surfaces in an environment. For example, a “time-of-flight sensor” refers to a specific type of depth sensor that may operate by emitting a signal and measuring the time it takes for the signal to reflect off a surface and return. An “eye tracking system” may refer to a system of sensors (e.g., inward-facing infrared cameras, etc.) and logic configured to monitor the position, orientation, and/or movement of a user's eye or eyes. A “vergence angle” may refer to the angle formed between the lines of sight of a user's two eyes as they converge to focus on an object, with the angle being inversely proportional to the object's distance.

As used herein, “emitters” may refer to individual light-generating components of a display panel, such as micro light emitting diodes (microLEDs), which are an emissive technology characterized by its microscopic size. A “waveguide” may refer to an optical element designed to guide and manipulate light from the emitters toward a user's eye. A “diffractive waveguide,” in particular, is used herein to refer to a specific type of waveguide that uses diffractive optical elements (e.g., gratings) to manipulate the light. A “monocular display device” may refer to a display device configured to present virtual content to only one of a user's eyes, while a “binocular display device” may refer to a display device configured to present virtual content to both eyes concurrently. A “push-pull lens system” may refer to a conventional optical assembly in some AR devices, typically comprising a “pull” lens to adjust the focus of virtual content and a “push” lens to cancel out the optical effect on the real-world view.

As used herein, a “controller” may refer to a processing unit, such as a central processing unit (CPU), graphics processing unit (GPU), or application-specific integrated circuit (ASIC), that is configured to execute instructions and orchestrate the operations of a device. A “non-transitory computer-readable medium” may refer to any tangible medium capable of storing instructions that can be executed by a controller. Examples may include random-access memory (RAM), read-only memory (ROM), flash memory, and magnetic or optical disks.

Various implementations will now be described in more detail with reference to the figures. It will be understood that particular implementations described below are provided as non-limiting examples and may be applied in various situations. Additionally, it will be understood that other implementations not explicitly described herein may also fall within the scope of the claims set forth below. Systems and methods for adaptive color determination for virtual content based on surface depth may result in any or all of the technical effects mentioned above, as well as various additional and/or alternative technical effects and benefits that will be described and/or made apparent below.

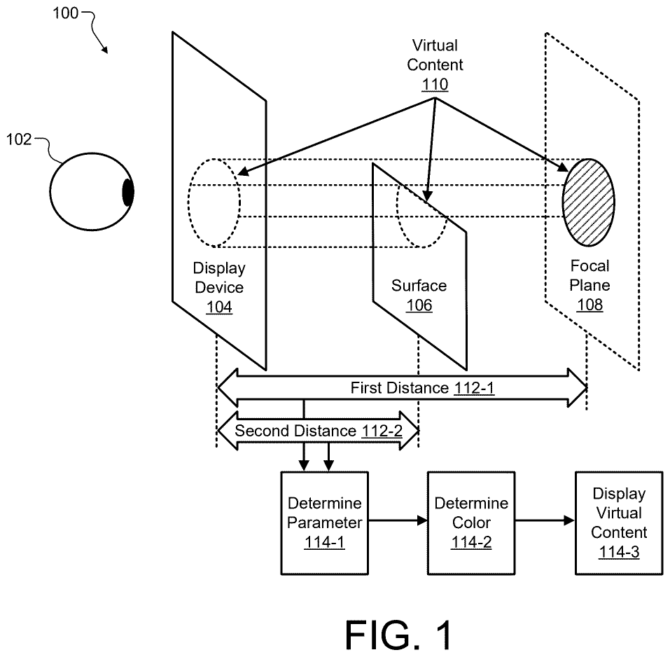

FIG. 1 shows an illustrative implementation 100 for adaptive color determination for virtual content in accordance with principles described herein. Implementation 100 provides a high-level conceptual overview of certain components, spatial relationships, and process flow that may be used to mitigate accommodation-related visual fatigue. The figure depicts an eye 102, which may represent an eye of a user who is viewing a scene that includes a combination of real-world objects and virtual content.

As shown, implementation 100 includes a display device 104, a surface 106, a focal plane 108, and virtual content 110. Display device 104 may be implemented as an extended reality (XR) device, such as a pair of augmented reality (AR) glasses or another type of head-mounted display, that is configured to present virtual content 110 to eye 102. Surface 106 may be a surface of a real-world object within an environment visible to the user (e.g., a menu onto which virtual text such as a language translation is to be overlaid). In operation, virtual content 110 may be presented by display device 104 at focal plane 108, though it is intended to appear to the user as being at least partially overlaid on surface 106. For this reason, as shown, while the full circle representing virtual content 110 is optically formed at focal plane 108, a portion of it is perceived by eye 102 as being overlaid on surface 106.

Implementation 100 further illustrates certain spatial relationships that give rise to the technical problem of accommodation fatigue. Specifically, the figure depicts a first distance 112-1 and a second distance 112-2. First distance 112-1 may represent the distance from display device 104 to focal plane 108. As described previously, focal plane 108 is the plane in space at which the optical system of display device 104 is configured to form a sharp virtual image, and this distance may be a fixed characteristic of the device. Second distance 112-2 may represent the distance from display device 104 to surface 106 (e.g., a surface within the field of view that eye 102 may look at and on which at least part of virtual content 110 may be overlaid). When first distance 112-1 and second distance 112-2 are significantly different, a user may experience eye strain as eye 102 attempts to rapidly re-accommodate between the two depths.

To address this, implementation 100 includes a process, illustrated by the flowchart at the bottom of the figure, that is configured to determine and apply a color to virtual content 110 to improve visual comfort. The process begins at an operation 114-1, where a controller of display device 104 may perform an operation of determining a parameter. This determining of the parameter may be based on a first distance from a display device to a focal plane for virtual content (e.g., first distance 112-1) and a second distance from the display device to a surface that is to be at least partially overlaid by the virtual content (e.g., second distance 112-2).

The process continues at an operation 114-2, where the controller performs an operation of determining, based on the parameter, a color for the virtual content. This operation involves selecting a specific spectral composition for virtual content 110 that is calculated to shift its apparent focal point to more closely align with the user's current accommodative state (assuming the user is accommodated to view surface 106).

The process then concludes at an operation 114-3, which illustrates an operation of displaying, by the display device, the virtual content at the focal plane with the color determined based on the parameter. This results in the user perceiving virtual content 110 as being sharper and more comfortable to view as the content is superimposed onto the real-world object having surface 106.

Display device 104 may be any suitable apparatus configured to perform the methods described herein. For example, display device 104 may be a head-mounted display that includes a see-through display, allowing a user to view both virtual content 110 and their real-world environment, including surface 106. In some implementations, display device 104 may be a monocular display device configured to present virtual content to a single eye of a user, which is a context where the technical solutions described herein are particularly beneficial. In other implementations, display device 104 may be a binocular display device configured to present content to both eyes of a user.

Surface 106 may be any surface within the field of view of display device 104. For example, surface 106 could be the surface of a nearby object, such as a book a user is reading or a tool they are using, or it could be a more distant surface, such as a wall or a sign across a room. In one example, mentioned above, surface 106 could be a surface of a menu onto which virtual text (e.g., a translation, nutritional information, etc.) is to be superimposed. Virtual content 110 may be any form of computer-generated information intended to augment the user's view of the real world. For example, virtual content 110 could be textual information (such as instructional text), graphical overlays (such as instructional arrows pointing to features on surface 106), or user interface elements.

To provide a more concrete example, consider a scenario where display device 104 is a pair of AR glasses and surface 106 is the surface of a physical menu being held by a user. In this example, second distance 112-2 from display device 104 to surface 106 might be approximately 40 centimeters. The optical system of display device 104 may be configured to present virtual content at a fixed focal plane 108, with first distance 112-1 being approximately two meters. The virtual content 110 in this scenario could be a real-time translation of the menu text, which is to be overlaid on the physical menu.

In this example scenario, the process would be performed as follows. At operation 114-1, a controller of display device 104 would determine a parameter based on the significant difference between first distance 112-1 (200 cm) and second distance 112-2 (40 cm). Because surface 106 is much closer than focal plane 108, the user's eye 102 will be accommodated for the near distance. At operation 114-2, the controller, based on the parameter, would determine a color for virtual content 110 that is shifted toward longer wavelengths (i.e., made more reddish). This leverages the natural optical properties of the eye, as described in more detail below. Finally, at operation 114-3, display device 104 would display the translated text (virtual content 110) with the determined reddish color, causing it to appear sharp and clear to the user without requiring them to re-accommodate their eye.

In summary, FIG. 1 illustrates a foundational implementation and process for improving user comfort in a see-through display device. By determining a parameter based on the relative distances of virtual content and an overlaid real-world surface, and then determining and displaying a color for the virtual content based on that parameter, the system can effectively mitigate the eye strain associated with accommodation fatigue. This provides a high-level overview of the technical solutions that will be described in more detail in the figures that follow.

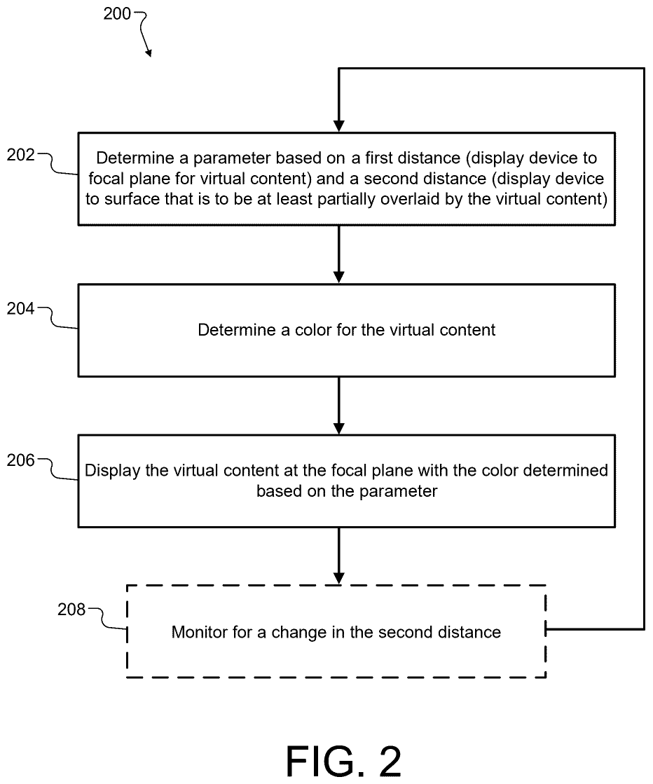

FIG. 2 shows a flowchart for an illustrative method 200 implementing adaptive color determination for virtual content in accordance with principles described herein. Method 200 provides a step-by-step illustration of one illustrative process that may be performed to address the technical problem of accommodation fatigue that has been described. The operations of method 200 may be performed by a display device described herein (e.g., display device 104 from FIG. 1), and may be executed by a controller of such a device based on instructions stored in a memory. While method 200 is shown with operations in a particular order for illustrative purposes, it will be understood that other implementations may reorder, add to, or omit certain operations. Furthermore, while the arrows may suggest a sequential order, it will be understood that some operations may be performed concurrently or in different orders. Each of the operations of method 200 will now be described.

At operation 202, a process may be performed of determining a parameter based on a first distance from a display device to a focal plane for virtual content and a second distance from the display device to a surface that is to be at least partially overlaid by the virtual content. This operation forms the primary input-gathering stage of the process, where the spatial relationship between the virtual content and the real-world environment is quantified. The first distance may be a fixed value associated with the optical properties of the display device, which may be identified by the controller based on a value stored in a memory. The second distance, in contrast, may be a variable that is determined in real-time (e.g., based on sensor data). The parameter determined at operation 202 may be a value or set of values that represents the relationship between these two distances. For example, the parameter may be a simple difference between the two distances (e.g., in meters), a diopter value representing the required change in accommodative effort, or another scaled or processed value that can be used as an input to a color determination algorithm.

At operation 204, a process may be performed of determining, based on the parameter, a color for the virtual content. This operation serves as a core computational step of method 200, where the controller calculates the specific spectral properties that will be used to render the virtual content to achieve the desired optical effect. The determination of the color at operation 204 may be performed in a variety of ways depending on the specific scenario and the nature of the virtual content. For example, if the parameter indicates that the second distance is less than the first distance (i.e., the surface is nearby), the determining of the color may include modifying a spectral property of a nominal color of the virtual content toward longer wavelengths. Conversely, if the parameter indicates the second distance is greater than the first distance, the determining of the color may include modifying a spectral property of the nominal color toward shorter wavelengths. In some implementations, such as for full-color or white content, the determining of the color may include modifying a white point associated with the virtual content. In another example, if the virtual content includes monochrome text, the determining of the color may include assigning a selected color to the monochrome text based on the parameter.

At operation 206, a process may be performed of displaying, by the display device, the virtual content at the focal plane with the color determined based on the parameter at operation 204. This operation represents the final output of the process, where the color-modified virtual content is presented to the user. The displaying of the virtual content at operation 206 may involve specific hardware actions that result in advantageous technical effects. For example, a controller may control a plurality of emitters to generate light with the determined color. In some implementations, particularly those using displays with per-channel color control (e.g., microLED displays), the determined color may omit a contribution of at least one primary color. In such a case, the displaying of the virtual content may include deactivating a corresponding set of emitters, which can result in a significant reduction in the power consumption of the display device.

As further shown in FIG. 2, method 200 may also include an optional, ongoing monitoring process, which is represented by a dashed box for an operation 208. The dashed lines indicate that this part of the method may be performed to make the process dynamic and adaptive to changes in the environment.

At operation 208, a process may be performed of monitoring for a change in the second distance from the display device to a surface that is to be at least partially overlaid by the virtual content. This monitoring can be continuous or periodic and allows the system to detect when the user has shifted their gaze, moved their head, or when objects have moved within the environment. As indicated by the feedback arrow from operation 208 back to operation 202, the system may be configured to react to the information gathered during monitoring. Specifically, the determining of the parameter at operation 202 and the determining of the color at operation 204 may be performed in response to detecting the change in the second distance. This responsive loop ensures that the color of the virtual content is always optimized for the current viewing context, providing a continuously comfortable and clear visual experience for the user.

In summary, FIG. 2 illustrates a complete and logical method for implementing adaptive color determination. By first determining a parameter based on relative distances, then determining a color based on that parameter, and finally displaying the color-modified content, method 200 provides a clear and effective technical solution to the problem of accommodation fatigue. The optional monitoring loop further illustrates how this solution can be made dynamic and responsive to a user's changing environment.

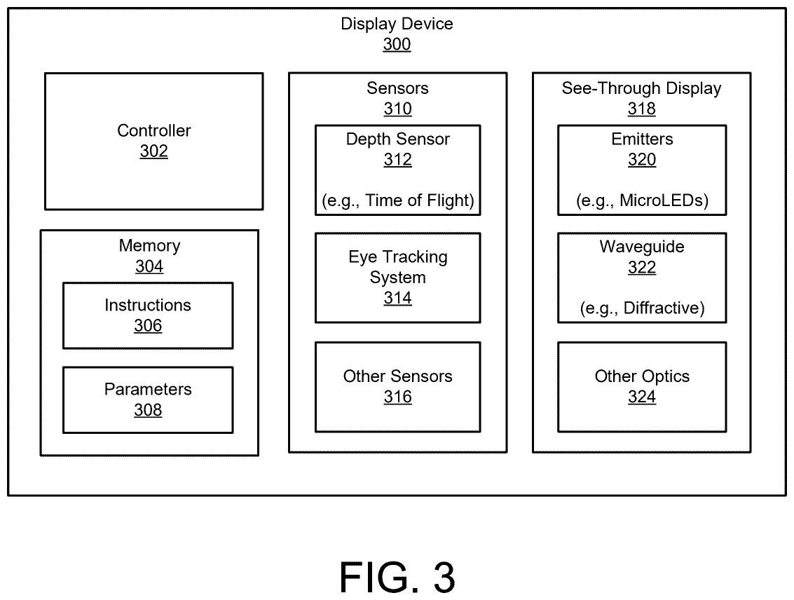

FIG. 3 shows a block diagram of an illustrative display device 300 configured for adaptive color determination for virtual content in accordance with principles described herein. The high-level display device 104 from FIG. 1 may be understood as an example implementation of the more detailed architecture of display device 300, which represents an apparatus configured to perform the methods and processes described herein, such as method 200. As illustrated, display device 300 may include various interconnected hardware and software components, which may be implemented within a single integrated system, such as a head-mounted display or a pair of AR glasses.

As shown, display device 300 may include a controller 302 and a memory 304. Controller 302 may be the central processing unit of display device 300, configured to orchestrate the operations of the various other components. Controller 302 may be implemented by one or more processors, such as a central processing unit (CPU), a graphics processing unit (GPU), an application-specific integrated circuit (ASIC), or another suitable processing unit. Memory 304 may be a non-transitory computer-readable medium, such as random-access memory (RAM) or flash memory, that is communicatively coupled to controller 302.

Memory 304 may be configured to store various data and instructions for use by controller 302. For example, memory 304 may store a set of instructions 306 that, when executed by controller 302, cause display device 300 to perform the operations described herein. Memory 304 may also store various parameters 308. For example, parameters 308 may include device-specific configuration data, such as a value representing the fixed first distance to the focal plane of the device. Parameters 308 may also include values that are determined during operation, such as the parameter determined at operation 202, which is based on the first distance and the second distance.

Display device 300 may further include one or more sensors 310. Sensors 310 may be configured to gather data from the environment and/or from a user of display device 300, and to provide this data to controller 302. This data may be used, for example, to determine the second distance to a surface in the environment. As shown, sensors 310 may include a depth sensor 312, an eye tracking system 314, and other sensors 316.

Depth sensor 312 may be an outward-facing sensor configured to determine the distance to objects and surfaces in the environment. For example, depth sensor 312 may be configured to determine the second distance based on a pose of the display device within the environment with respect to an object. In some implementations, depth sensor 312 may be a time-of-flight sensor configured to calculate the second distance based on a time that a signal takes to travel from the display device to the surface. Data from depth sensor 312 may thus be used by controller 302 as a basis for determining the parameter.

Eye tracking system 314 may be an inward-facing sensor system configured to analyze an eye of a user of the display device. For example, eye tracking system 314 may include one or more infrared cameras and illuminators. Controller 302 may use data generated by eye tracking system 314 to indicate that a gaze of the eye is directed to a surface of an object. In implementations where display device 300 is a binocular device, eye tracking system 314 may be configured to analyze two eyes of the user to determine a vergence angle, which can be used to determine the second distance as a distance to an object that the user is currently looking at. In some implementations, data from eye tracking system 314 may be used in combination with additional data from depth sensor 312 to determine the parameter.

Other sensors 316 may include any other sensors that may be useful for the operation of display device 300. For example, other sensors 316 may include an inertial measurement unit (IMU), which may be used to track the position and orientation (i.e., the pose) of display device 300. This pose information may be used by controller 302 in conjunction with data from depth sensor 312 to accurately determine the second distance.

Display device 300 may also include a see-through display 318. See-through display 318 is the primary output component of the device, configured to present virtual content to the user while also allowing the user to see their real-world environment. In some implementations, display device 300 may be a monocular display device, in which case see-through display 318 would be configured to direct light to present the virtual content to one eye of a user. In other implementations, display device 300 may be a binocular display device, in which case see-through display 318 would be configured to direct light to present the virtual content to both eyes of a user. See-through display 318 may include a plurality of emitters 320, a waveguide 322, and other optics 324.

The plurality of emitters 320 are the light-generating components of see-through display 318. Emitters 320 may be configured to generate light representing virtual content under the control of controller 302. In some implementations, the plurality of emitters 320 may include a plurality of micro light emitting diodes (microLEDs). The plurality of emitters may include a first set of emitters configured to generate light of a first primary color (e.g., red) and a second set of emitters configured to generate light of a second primary color (e.g., blue), allowing controller 302 to implement power-saving techniques by deactivating one of the sets. Other sets of emitters (e.g., green) may also be included and activated or deactivated in a similar way as further described below.

Waveguide 322 is an optical element configured to manipulate the light generated by the plurality of emitters 320. Specifically, waveguide 322 may be configured to receive the light from emitters 320 and direct it toward the user's eye, thereby displaying the virtual content at a focal plane a first distance from the apparatus. In some implementations, waveguide 322 includes a diffractive waveguide that includes a pair of incoupling gratings and outcoupling gratings and functions by selectively redirecting light from emitters 320.

Other optics 324 may represent any other optical components, such as lenses, coatings, or polarizers, that may be part of the optical path of see-through display 318. In some implementations, the optical system of display device 300 may be significantly simplified by leveraging the software-based color determination methods described herein. For example, in some implementations, the waveguide may be configured to focus the focal plane at an infinite distance, and based on operations performed by the controller, the apparatus may display the virtual content at the focal plane at the first distance without a push-pull lens system configured to adjust the focal plane from the infinite distance to the first distance.

In overall operation, the components of display device 300 may interoperate as an integrated system. Sensors 310 may gather real-time data about the environment and the user. Controller 302, executing instructions 306 from memory 304, may process this sensor data to determine a parameter and, based on that parameter, determine a color for the virtual content. Controller 302 may then control the plurality of emitters 320 to display the virtual content at the focal plane with the determined color, with waveguide 322 directing the color-modified light to the user. This integrated operation allows display device 300 to function as an apparatus that provides a comfortable and clear viewing experience.

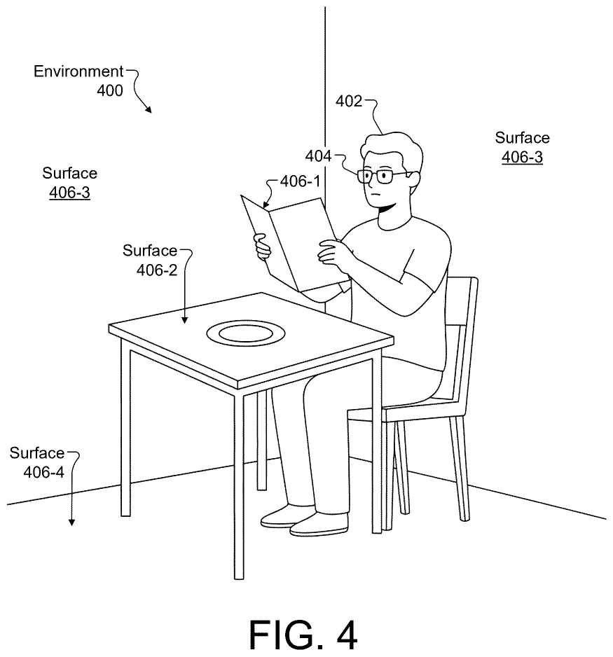

FIG. 4 shows an illustrative environment 400 for implementing adaptive color determination for virtual content in accordance with principles described herein. This figure provides a practical, real-world context to illustrate how the color-based modification methods described herein can be applied in a dynamic setting with multiple potential surfaces of interest. As shown, the figure depicts a user 402 who is wearing and operating a display device 404. Display device 404 may be an example implementation of display device 300, as described with reference to FIG. 3.

Environment 400 may include various objects and surfaces at a range of different distances from user 402 and display device 404. For example, the figure illustrates several such surfaces, including a surface 406-1 of a handheld menu, a surface 406-2 of a tabletop, one or more surfaces 406-3 of the walls, and a surface 406-4 of the floor. Each of these surfaces represents a potential real-world surface that may be at least partially overlaid by virtual content, and thus each represents a potential second distance that the system may need to account for when determining a color for the virtual content.

This figure may be used to illustrate the technical problem of accommodation fatigue in a concrete example. In the scenario shown, user 402 is holding a menu, and display device 404 is to overlay virtual content (e.g., a translation of the menu text) onto surface 406-1 of that menu. The second distance from display device 404 to surface 406-1 may be quite small, such as approximately 30 or 40 centimeters. The optical system of display device 404, however, may have a fixed focal plane at a much greater first distance, such as two meters (i.e., 200 centimeters). This significant mismatch between the first distance and the second distance would require user 402 to constantly re-accommodate their eyes to switch focus between the physical menu and the virtual translation, leading to eye strain.

To address this, display device 404 may perform methods and techniques described herein. For example, a controller of display device 404 may determine a parameter based on the first distance (e.g., 2 m) and the second distance (e.g., 0.4 m to surface 406-1). This parameter may be a value representing the difference between the two distances (e.g., 1.6 m), a diopter value, or another scaled value that the controller uses as an input to a color-determination algorithm. Based on this parameter indicating that surface 406-1 is much closer than the focal plane, the controller would then determine a color for the virtual content that is shifted toward longer wavelengths, making it appear sharp to an eye accommodated for the near distance.

In some implementations, the system may operate using an outward-facing depth sensor to determine the second distance. For example, a depth sensor on display device 404 may scan environment 400 to generate a depth map. When virtual content is to be displayed over the menu, the controller may identify that surface 406-1 is the nearest surface within the display's field of view to be at least partially overlaid by the virtual content. The controller may then use the measured depth of surface 406-1 from the depth map as the second distance for determining the parameter.

In other implementations, the system may operate using an eye tracking system. For example, an eye tracking system within display device 404 may be used to analyze an eye of user 402. The controller may determine the parameter based on data generated by the eye tracking system that indicates that a gaze of the eye is directed to surface 406-1 of the object. This allows the system to confirm that the menu is the current object of interest for the user, and that the distance to surface 406-1 is the correct second distance to use for the color determination process.

FIG. 4 also illustrates the dynamic nature of the system. For example, user 402 might put the menu down on the table, such that its surface is now at the distance of surface 406-2, and then shift their gaze to look at the wall at surface 406-3. Display device 404 may be configured to monitor for a change in the second distance. If new virtual content were to be displayed (e.g., a notification overlaid on the wall), the controller would detect the new, larger second distance to surface 406-3. In response to detecting the change in the second distance, the controller may determine a new parameter and a new color for the virtual content. For this new scenario, the determined color may be shifted toward shorter wavelengths to align the focus with the more distant surface.

In summary, FIG. 4 illustrates how a display device may intelligently adapt to a user's actions and focus within a complex real-world environment. By dynamically adjusting the color of virtual content based on the context provided by the various surfaces in the environment, the system can provide a continuously comfortable and clear viewing experience.

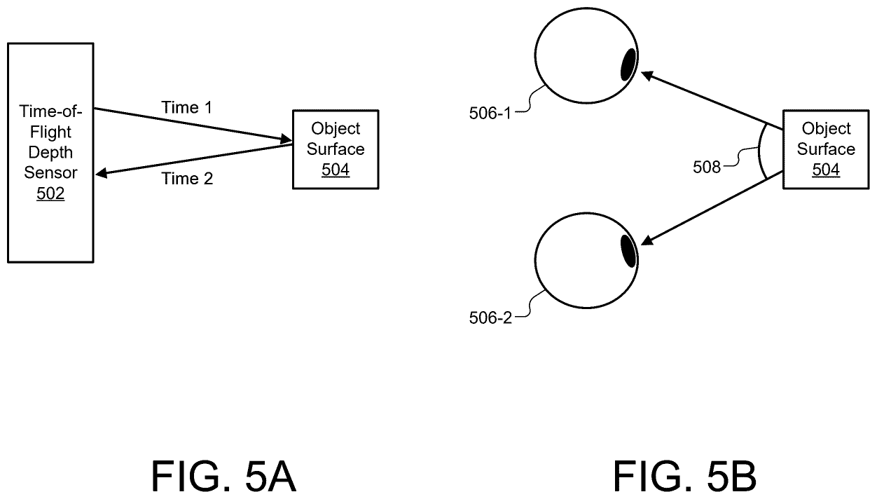

FIGS. 5A and 5B show aspects of illustrative techniques for determining a surface depth for adaptive color determination in accordance with principles described herein. More specifically, these figures illustrate two example techniques that a display device may use, either individually or in combination, to determine the “second distance” from a display device to a real-world surface in the environment (and onto which virtual content is to be at least partially overlaid). FIG. 5A illustrates a device-centric, active sensing technique, while FIG. 5B illustrates a user-centric technique based on physiological cues from the user's eyes.

Referring first to FIG. 5A, this figure illustrates an active sensing technique that may be used to determine a distance to an object surface 504. To perform this technique, a display device may include a time-of-flight depth sensor 502, which may be an example implementation of depth sensor 312 from FIG. 3. Object surface 504 may be any surface in the environment, such as surface 106 or any of surfaces 406-1 through 406-4 described previously.

FIG. 5A further illustrates the principle of operation of time-of-flight depth sensor 502. The sensor may be configured to emit a signal, such as a pulse of light (e.g., infrared light), that travels through the environment until it reflects off object surface 504. The reflected signal then travels back and is received by a detector on time-of-flight depth sensor 502. As illustrated, the time it takes for the signal to travel from the sensor to the surface is represented as “Time 1,” and the time it takes for the reflected signal to travel from the surface back to the sensor is represented as “Time 2.” A controller of the device may then calculate the second distance to object surface 504 based on a time that the signal takes to travel from the display device to the surface. For example, the controller may calculate the distance based on the one-way travel time (e.g., Time 1) or the total round-trip travel time (Time 1+Time 2) and the known speed of the signal (i.e., the speed of light).

Referring now to FIG. 5B, this figure illustrates an alternative technique for determining the distance to object surface 504, based on the physiology of a user's visual system when the user's gaze is directed at the object (at whatever distance away it is). The figure depicts a user's two eyes, a first eye 506-1 and a second eye 506-2, as they focus on object surface 504. This technique is particularly applicable to binocular display devices that may include an eye tracking system.

The principle of binocular vergence is illustrated in this figure. When a user focuses on a nearby object, such as object surface 504, their eyes 506-1 and 506-2 naturally rotate inward (i.e., converge) to align their respective lines of sight on the object. The angle formed between these lines of sight is the vergence angle 508. As shown, vergence angle 508 is inversely proportional to the distance of object surface 504; a larger angle corresponds to a closer object, while a smaller angle corresponds to a more distant object.

To implement this technique, an eye tracking system may be configured to analyze the two eyes of the user. The controller may determine a parameter based on data generated by the eye tracking system. For example, the determining of the parameter may include determining, based on the data generated by the eye tracking system, a vergence angle of the two eyes of the user, and then determining the second distance based on the vergence angle. This provides another effective method for determining the second distance, in this case based on the user's direct point of focus.

In some implementations, the techniques illustrated in FIGS. 5A and 5B may be used in combination to provide a more robust and accurate determination of the second distance. For example, a system may use a depth sensor to generate a general depth map of the environment, and may also use an eye tracking system to determine which specific surface on that map the user's gaze is directed to. In such a case, the determining of the parameter may be based on a combination of the data generated by the eye tracking system and additional data generated by a depth sensor.

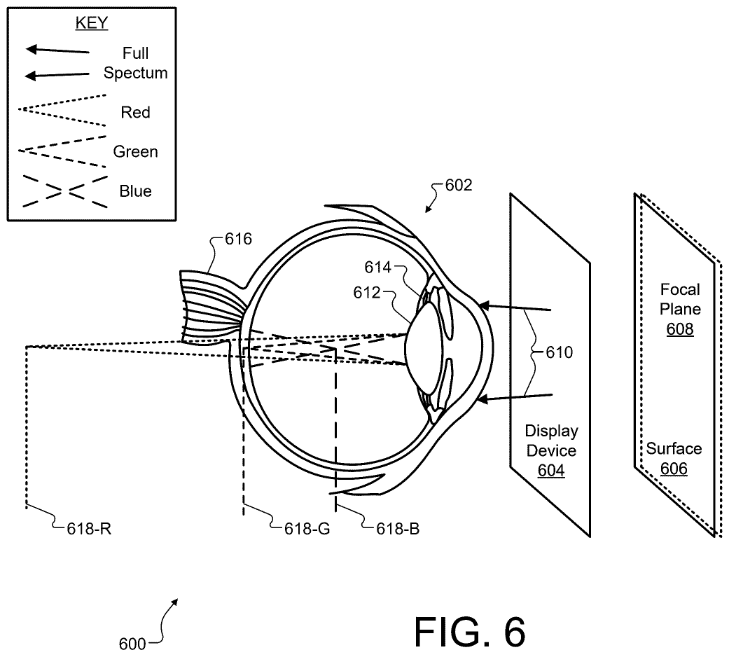

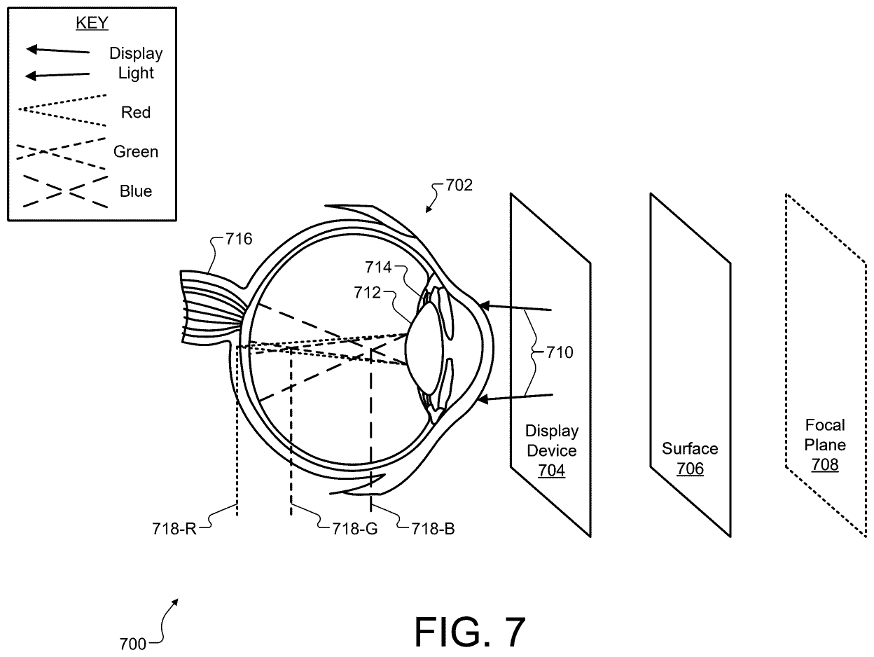

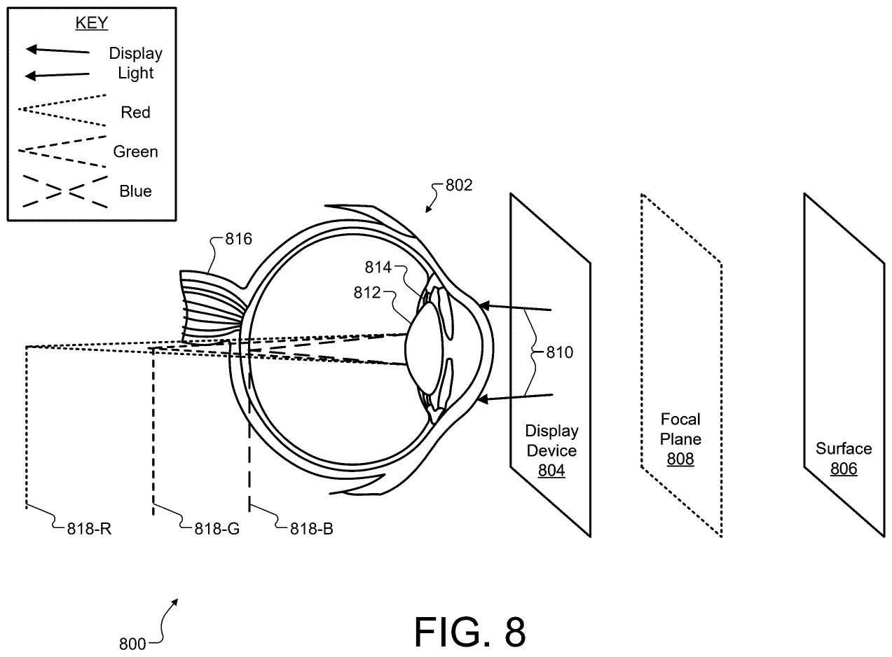

FIGS. 6-8 show several illustrative scenarios related to adaptive color determination for virtual content in accordance with principles described herein. These figures are presented as a group of diagrams that illustrate the optical principles that enable the color-based modification of virtual content. More specifically, FIG. 6 shows a baseline scenario, while FIGS. 7 and 8 show two corrective scenarios that may be implemented by technical solutions described herein. It will be noted that these figures use a consistent numbering scheme for corresponding elements to aid in understanding (e.g., an eye 602 in FIG. 6 corresponds to an eye 702 in FIG. 7 and an eye 802 in FIG. 8).

Referring first to FIG. 6, this figure illustrates a baseline scenario 600. The figure depicts several components in a specific spatial layout, including an eye 602, a display device 604, a real-world surface 606, and a virtual focal plane 608. In this baseline scenario, surface 606 and focal plane 608 are essentially co-located at the same approximate distance from eye 602. Display device 604 is shown emitting full spectrum light 610 toward eye 602. As indicated by a key in the corner of the figure, full spectrum light 610 includes components of red (R), green (G), and blue (B) light that, themselves are each represented by a different line style (dotted for red, small dashes for green, and larger dashes for blue). Eye 602 is also shown with its key anatomical components, including a lens 612, ciliary muscles 614 that are configured to contract and relax to change the shape and focal power of lens 612, a light-sensitive retina that lines the back surface of eye 602, and an optic nerve 616 that is configured to transmit visual signals from the retina to the brain.

FIG. 6 further illustrates the fundamental optical principle of longitudinal chromatic aberration (LCA). When full spectrum light 610, representing the virtual content, passes through lens 612, the lens refracts different wavelengths of light by different amounts. As shown, this causes shorter wavelengths (blue light) to converge at a relatively near focal point 618-B, medium wavelengths (green light) to converge at an intermediate focal point 618-G (approximately at the retina in this example), and longer wavelengths (red light) to converge at a relatively far focal point 618-R.

In the baseline scenario 600, eye 602 is accommodated to see surface 606 clearly. To achieve this, ciliary muscles 614 adjust the shape of lens 612 to bring the light into focus. As shown in the diagram, this baseline state of accommodation results in the focal point for green light (focal point 618-G) landing directly on or near the retina. This represents a normal state of focus that the human visual system is accustomed to, where the primary component of vision is sharp, even with the slight defocus of the red and blue components.

Referring now to FIG. 7, this figure illustrates a scenario 700, which depicts a corrective action for a near surface. The figure shows several components, including an eye 702 (with a lens 712, ciliary muscles 714, and an optic nerve 716), a display device 704, a surface 706, a focal plane 708, and display light 710, which may be shifted in the ways described below. In the spatial layout shown, surface 706 is positioned significantly closer to eye 702 than the device's focal plane 708. This represents a situation where the first distance (from display device 704 to focal plane 708) is greater than the second distance (from display device 704 to surface 706).

To bring the nearby surface 706 into sharp focus, a physiological response occurs in eye 702. The ciliary muscles 714 contract, which releases tension on lens 712, allowing it to become thicker, more convex, and thus more optically powerful. This action of accommodation pulls all the focal points for light entering the eye significantly forward (i.e., closer to lens 712).

This accommodation for the near surface creates a technical problem for the virtual content. If display device 704 were to emit full spectrum light, the increased power of the accommodated lens 712 would cause all of its focal points (e.g., focal points corresponding to red, green, and blue light, such as focal point 718-R, focal point 718-G, and focal point 718-B) to converge in front of the retina. This would cause the virtual content, which is optically presented at the more distant focal plane 708, to appear blurry to the user.

To address this, display device 704 may be configured to perform a corrective action. Specifically, the device may determine a color for the virtual content that includes modifying a spectral property of a nominal color toward longer wavelengths. This “red-shift” is illustrated by the modified light 710, which may be modified to now consist primarily of red and green components. Because red light has the longest natural focal length, its focal point 718-R is the one that can best compensate for the increased power of the accommodated lens 712 and land correctly on the retina. This corrective action allows the virtual content to appear sharp to the user, even while their eye is accommodated for the nearby surface 706.

Referring now to FIG. 8, this figure illustrates a scenario 800, which depicts a corrective action for a far surface. The figure shows several components, including an eye 802 (with a lens 812, ciliary muscles 814, and an optic nerve 816), a display device 804, a surface 806, a focal plane 808, and display light 810, which may be shifted in the ways described below. In the spatial layout shown, surface 806 is positioned significantly farther from eye 802 than the device's focal plane 808. This represents a situation where the first distance (from display device 804 to focal plane 808) is less than the second distance (from display device 804 to surface 806).

To bring the distant surface 806 into sharp focus, an opposite physiological response occurs in eye 802. The ciliary muscles 814 relax, which increases tension in suspensory ligaments (not shown) attached to lens 812, thereby pulling lens 812 into a flatter, less powerful shape. This action of accommodation pushes all the focal points for light entering the eye backward (i.e., farther from lens 812).

This accommodation for the far surface creates a different technical problem for the virtual content. If display device 804 were to emit full spectrum light, the reduced power of the relaxed lens 812 would cause the focal points for the virtual content (e.g., focal points corresponding to red, green, and blue light, such as focal point 818-R, focal point 818-G, and focal point 818-B) at the closer focal plane 808 to converge behind the retina. This would also cause the virtual content to appear blurry.

To address this, display device 804 may perform an opposite corrective action. Specifically, the device may determine a color for the virtual content that includes modifying a spectral property of a nominal color toward shorter wavelengths. This “blue-shift” is illustrated by the modified light 810, which now consists primarily of green and blue components. Because blue light has the shortest natural focal length, its focal point 818-B is the one that can best compensate for the reduced power of the relaxed lens 812 and land correctly on the retina. This corrective action allows the virtual content to appear sharp to the user, even while their eye is accommodated for the distant surface 806.

In some implementations, the red-shift of FIG. 7 and the blue-shift of FIG. 8 may be implemented in various ways. For example, in situations where the virtual content is full-color or is nominally white, the determining of the color for the virtual content may include modifying a white point associated with the virtual content. Specifically, the white point may be shifted to be “warmer” (i.e., more reddish) to achieve the effect of FIG. 7, or shifted to be “cooler” (i.e., more bluish) to achieve the effect of FIG. 8. In summary, FIGS. 6-8 collectively provide a detailed scientific basis for how a display device may leverage the natural longitudinal chromatic aberration of the human eye, applying specific, directional color shifts to virtual content to align its apparent focal distance with a user's current point of accommodation.

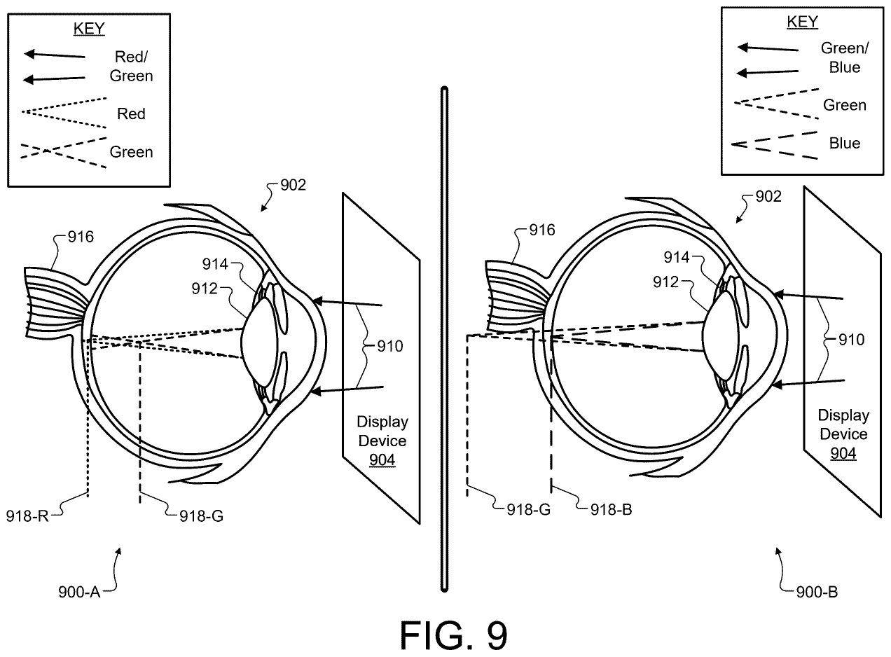

FIG. 9 shows further illustrative scenarios for implementing adaptive color determination for virtual content in accordance with principles described herein. More specifically, FIG. 9 shows a scenario 900-A and a scenario 900-B, which together illustrate a practical implementation of the color modification methods described in relation to FIGS. 7 and 8. These scenarios show how the directional color shifts may be performed on a display device with discrete color channels (e.g., an RGB microLED display) and highlight a resulting technical effect of improved power efficiency.

Referring first to scenario 900-A, this figure illustrates an example implementation of the “red-shift” correction for a near surface, as was detailed in the description of FIG. 7. Scenario 900-A includes several components, such as an eye 902 (with a lens 912, ciliary muscles 914, and an optic nerve 916), a display device 904, and light 910. As in the previous figures, the back surface of eye 902 may be understood to be a retina, onto which light is focused.

Scenario 900-A illustrates a specific hardware-level action that may be performed to achieve the desired red-shift. In this scenario, a controller of display device 904 has determined that a red-shift is required (e.g., because a nearby surface is being overlaid). To achieve this, the determining of the color for the virtual content may include omitting a contribution of the blue primary color. As a result, the light 910 emitted by the device consists only of red and green components, as shown by the key in the figure and the presence of only focal point 918-R and focal point 918-G.

This action may be directly tied to the operation of the display's emitters. For example, the display device may include a plurality of emitters including a first set of emitters configured to generate light of a first primary color (e.g., red or green) and a second set of emitters configured to generate light of a second primary color different from the first (e.g., blue). To present the content, the displaying of the virtual content with the color determined based on the parameter may include deactivating, based on the omitting of the contribution of the second primary color, the second set of emitters. This deactivation of an entire color channel of emitters may thus provide a dual technical benefit: it directly results in a reduction of power consumption of display device 904 while also producing the color-shifted light that helps the user to more easily accommodate to the virtual content presented to overlay the near surface.

Referring now to scenario 900-B, this figure illustrates an example implementation of the “blue-shift” correction for a far surface, as was detailed in the description of FIG. 8. Scenario 900-B includes corresponding components, such as an eye 902, a display device 904, light 910, a lens 912, ciliary muscles 914, an optic nerve 916, and various focal points (e.g., focal point 918-G and focal point 918-B).

Scenario 900-B illustrates a parallel action for the blue-shift scenario. In this case, the controller has determined that a blue-shift is required (e.g., because a distant surface is being overlaid). To achieve this, the determining of the color may include omitting a contribution of the red primary color. As a result, the light 910 emitted by display device 904 now consists only of green and blue components, as shown by the key and the presence of only focal point 918-G and focal point 918-B.

Similar to the red-shift case, this may be implemented at the hardware level to save power. In this case, the displaying of the virtual content may include deactivating the set of emitters for the red primary color. This action likewise provides a dual technical benefit: it reduces the overall power consumption of display device 904, while also producing the color-shifted light that helps the user to more easily accommodate to the virtual content presented to overlay the far surface.

In summary, FIG. 9 illustrates a practical and efficient method for implementing the color-based accommodation assistance. It will also be understood that, in other implementations, a more aggressive color shift may be performed to achieve even greater power savings, such as by deactivating two of the three primary color channels and displaying the content using only a single primary color (e.g., using only red emitters or only blue emitters). By selectively omitting the contribution of certain primary colors and deactivating the corresponding sets of emitters, the system not only achieves the desired optical correction for enhanced user comfort but also realizes a significant technical benefit in power efficiency. This is particularly advantageous for mobile, battery-powered display devices, such as AR glasses.

The color shifts described herein may be applied in a dynamic and context-dependent manner. As a user moves their head, shifts their gaze, or as objects move within the environment, the second distance to the overlaid surface may change, triggering a corresponding change in the determined color. The speed and magnitude of this color change may be configured based on the specific application. For example, in an industrial application where a user is viewing monochrome text instructions, the color of the text may change instantaneously from a reddish hue to a bluish hue as the user looks from a nearby component to a distant control panel. In such a context, immediate clarity and comfort may be prioritized over aesthetic consistency. In contrast, for a consumer application displaying a full-color photograph, the color change may be applied more gradually, for example, by smoothly shifting a white point over a fraction of a second. This more subtle transition may prevent a jarring color flash and make the correction less noticeable to the user, preserving the aesthetic integrity of the content.

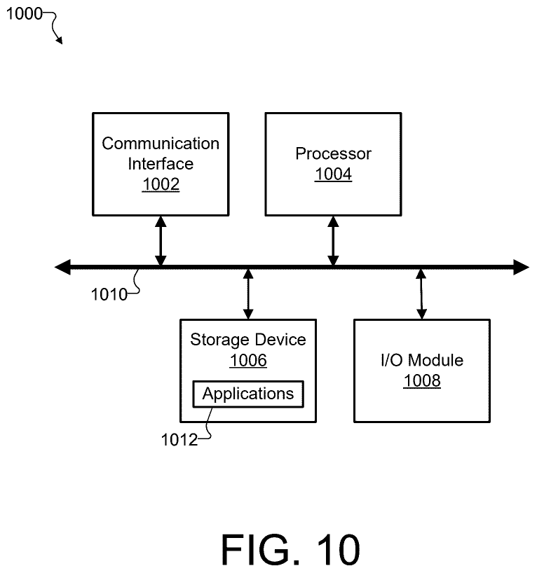

FIG. 10 shows a block diagram of an illustrative computing system 1000 for implementing adaptive color determination for virtual content in accordance with principles described herein. Computing system 1000 provides an example of a general-purpose computing environment that can be configured to perform the methods and processes described herein. For example, computing system 1000 may be used to implement the hardware of a display device, such as display device 300, or a controller thereof, such as controller 302.

As shown, computing system 1000 may include a communication interface 1002, a processor 1004, a storage device 1006, and an input/output (I/O) module 1008. These components may be communicatively connected via a communication infrastructure, such as a bus 1010, which facilitates data and control signal exchange between the various components. While a particular computing system 1000 is shown, it will be understood that the components illustrated are not intended to be limiting, as additional or alternative components may be included in other implementations.

Processor 1004 generally represents any type or form of processing unit capable of interpreting and executing instructions, such as those stored as applications 1012 in storage device 1006. For example, processor 1004 may be an implementation of controller 302 and may direct the execution of the methods described herein, such as method 200. Processor 1004 may include one or more central processing units (CPUs), one or more graphics processing units (GPUs), or a combination thereof.

Storage device 1006 may include one or more data storage media, devices, or configurations and may be an implementation of a non-transitory computer-readable medium. Storage device 1006 may include, without limitation, random-access memory (RAM), read-only memory (ROM), a hard drive, flash memory, or a combination thereof. Storage device 1006 is shown to store one or more applications 1012. Applications 1012 may represent computer-executable instructions that, when executed by processor 1004, cause computing system 1000 to perform the disclosed methods for adaptive color determination. In addition, storage device 1006 may also be used to store other data, such as parameters 308.

Communication interface 1002 may be configured to communicate with one or more other computing devices or networks, for example, to receive virtual content for presentation on a display. I/O module 1008 may be configured to receive input from various sensors, such as depth sensor 312 and eye tracking system 314, and to provide output signals to control display components, such as emitters 320.

In operation, the components of computing system 1000 may interoperate to perform the functions described herein. For example, processor 1004 may execute applications 1012 stored in storage device 1006. Executing the instructions may cause processor 1004 to receive sensor data via I/O module 1008, determine the appropriate parameter and color, and then control the display emitters via I/O module 1008 to perform the process of displaying the color-modified virtual content.

The following clauses describe implementations of adapting color for virtual content based on surface depth in accordance with principles described herein.
Clause 1. A method comprising: determining a characteristic for virtual content to be displayed by a display device within a field of view of the display device, the characteristic being determined based on: a first distance from the display device to a focal plane for the virtual content, and a second distance from the display device to a surface visible in a region of the field of view associated with the virtual content; and displaying, by the display device, the virtual content at the focal plane with the characteristic.
Clause 2. The method of clause 1, wherein: the surface is associated with an object in an environment in which the display device is operated; the display device includes a depth sensor configured to determine the second distance based on a pose of the display device within the environment with respect to the object; and the determining of the characteristic includes identifying the first distance based on a value stored in a memory and determining the second distance using the depth sensor.
Clause 3. The method of clause 2, wherein the depth sensor is a time-of-flight sensor configured to calculate the second distance based on a time that a signal takes to travel from the display device to the surface.
Clause 4. The method of clause 1, wherein: the virtual content is associated with a nominal color; the characteristic is a color for the virtual content different from the nominal color; and the determining of the characteristic includes: determining a parameter based on a difference between the first distance and the second distance, the first distance being greater than the second distance; and determining the color for the virtual content based on the parameter by modifying a spectral property of the nominal color toward longer wavelengths based on the first distance being greater than the second distance.
Clause 5. The method of clause 1, wherein: the virtual content is associated with a nominal color; the characteristic is a color for the virtual content different from the nominal color; and the determining of the characteristic includes: determining a parameter based on a difference between the first distance and the second distance, the first distance being less than the second distance; and determining the color for the virtual content based on the parameter by modifying a spectral property of the nominal color toward shorter wavelengths based on the first distance being less than the second distance.
Clause 6. The method of clause 1, wherein: the characteristic is a color for the virtual content; and the determining of the characteristic includes modifying a white point associated with the virtual content based on a parameter representing the first distance and the second distance.
Clause 7. The method of clause 1, wherein: the surface is associated with an object in an environment in which the display device is operated; the display device includes an eye tracking system configured to analyze an eye of a user of the display device; and the determining of the characteristic is based on data generated by the eye tracking system to indicate that a gaze of the eye is directed to the surface of the object.
Clause 8. The method of clause 7, wherein the determining of the characteristic is based on a combination of: the data generated by the eye tracking system to indicate that the gaze of the eye is directed to the surface of the object; and additional data generated by a depth sensor configured to determine the second distance based on a pose of the display device within the environment with respect to the object.
Clause 9. The method of clause 7, wherein: the eye tracking system is configured to analyze two eyes of the user; and the determining of the characteristic includes: determining, based on the data generated by the eye tracking system, a vergence angle of the two eyes of the user; and determining the second distance based on the vergence angle.
Clause 10. The method of clause 1, wherein: the characteristic is a color for the virtual content; the display device includes a plurality of emitters including: a first set of emitters configured to generate light of a first primary color, and a second set of emitters configured to generate light of a second primary color different from the first primary color; the determining of the characteristic for the virtual content includes omitting a contribution of the second primary color within the color for the virtual content; and the displaying of the virtual content with the characteristic includes deactivating, based on the omitting of the contribution of the second primary color within the color, the second set of emitters.
Clause 11. The method of clause 1, wherein: the characteristic is a color for the virtual content; the virtual content includes monochrome text; and the determining of the characteristic for the virtual content includes assigning a selected color to the monochrome text based on the first distance and the second distance.
Clause 12. The method of clause 1, further comprising monitoring for a change in the second distance from the display device to the surface visible in the region associated with the virtual content; wherein the determining of the characteristic is performed in response to detecting the change in the second distance.
Clause 13. An apparatus comprising: a plurality of emitters configured to generate light representing virtual content; a waveguide configured to manipulate the light generated by the plurality of emitters to display the virtual content at a focal plane a first distance from the apparatus; and a controller configured to: determine a characteristic based on the first distance and based on a second distance from the apparatus to a surface visible in a region of a field of view associated with the virtual content; and control the plurality of emitters to display the virtual content at the focal plane with the characteristic.
Clause 14. The apparatus of clause 13, wherein: the surface is associated with an object in an environment in which the apparatus is operated; the apparatus further comprises a depth sensor configured to determine the second distance based on a pose of the apparatus within the environment with respect to the object; and the controller is further configured to determine the second distance using the depth sensor.
Clause 15. The apparatus of clause 13, wherein: the apparatus is a monocular display device; and the waveguide is configured to direct the light generated by the plurality of emitters to present the virtual content to one eye of a user.
Clause 16. The apparatus of clause 13, wherein the plurality of emitters includes a plurality of micro light emitting diodes (microLEDs) and the waveguide includes a diffractive waveguide.
Clause 17. The apparatus of clause 13, wherein: the waveguide is configured to focus the focal plane at an infinite distance; and based on operations performed by the controller, the apparatus displays the virtual content at the focal plane at the first distance without a push-pull lens system configured to adjust the focal plane from the infinite distance to the first distance.
Clause 18. A non-transitory computer-readable medium storing instructions that, when executed, cause a controller of a display device to perform a process comprising: determining a characteristic for virtual content to be displayed by the display device within a field of view of the display device, the characteristic being determined based on: a first distance from the display device to a focal plane for the virtual content, and a second distance from the display device to a surface visible in a region of the field of view associated with the virtual content; and causing the display device to display the virtual content at the focal plane with the characteristic.
Clause 19. The non-transitory computer-readable medium of clause 18, wherein: the virtual content is associated with a nominal color; the characteristic is a color for the virtual content different from the nominal color; and the determining of the characteristic includes: determining a parameter based on a difference between the first distance and the second distance, the first distance being greater than the second distance; and determining the color for the virtual content based on the parameter by modifying a spectral property of the nominal color toward longer wavelengths based on the first distance being greater than the second distance.
Clause 20. The non-transitory computer-readable medium of clause 18, wherein: the virtual content is associated with a nominal color; the characteristic is a color for the virtual content different from the nominal color; and the determining of the characteristic includes: determining a parameter based on a difference between the first distance and the second distance, the first distance being less than the second distance; and determining the color for the virtual content based on the parameter by modifying a spectral property of the nominal color toward shorter wavelengths based on the first distance being less than the second distance.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A number of implementations have been described. It will be understood that various modifications may be made without departing from the spirit and scope of the description and claims. The described implementations are examples, and that other systems can be used to perform similar functions. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the implementations of the disclosure.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the term “comprising,” when used in this specification, specifies the presence of the stated features, steps, operations, elements, and/or components, but does not preclude the presence or addition of one or more other features, steps, operations, elements, components, and/or groups thereof.

It will be understood that when an element is referred to as being “coupled” or “connected” to another element, it can be directly coupled or connected to the other element, or intervening elements may also be present. In contrast, when an element is referred to as being “directly coupled” or “directly connected” to another element, there are no intervening elements present.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (e.g., rotated 90 degrees or at other orientations) and the spatially relative descriptors used herein may be interpreted accordingly.

Further to the descriptions above, a user may be provided with controls allowing the user to make an election as to both if and when systems, programs, or features described herein may enable collection of user information (e.g., information about a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized, such as to a city, zip code, or state level, so that a particular location of a user cannot be determined. Thus, the user may have control over what information is collected about the user, how that information is used, and what information is provided to the user.

While certain features of the described implementations have been illustrated as described herein, many modifications, substitutions, changes, and equivalents may occur to those skilled in the art. It is therefore to be understood that the appended claims are intended to cover such modifications and changes as fall within the scope of the implementations. It will be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described. As such, the scope of the present disclosure is not limited to the particular combinations hereafter claimed, but instead extends to encompass any combination of features or example implementations described herein irrespective of whether or not that particular combination has been specifically enumerated in the accompanying claims at this time.

What is claimed is:

1. A method comprising:
determining a characteristic for virtual content to be displayed by a display device within a field of view of the display device, the characteristic being determined based on:
a first distance from the display device to a focal plane for the virtual content, and
a second distance from the display device to a surface visible in a region of the field of view associated with the virtual content; and
displaying, by the display device, the virtual content at the focal plane with the characteristic.

2. The method of claim 1, wherein:
the surface is associated with an object in an environment in which the display device is operated;
the display device includes a depth sensor configured to determine the second distance based on a pose of the display device within the environment with respect to the object; and
the determining of the characteristic includes identifying the first distance based on a value stored in a memory and determining the second distance using the depth sensor.

3. The method of claim 2, wherein the depth sensor is a time-of-flight sensor configured to calculate the second distance based on a time that a signal takes to travel from the display device to the surface.

4. The method of claim 1, wherein:
the virtual content is associated with a nominal color;
the characteristic is a color for the virtual content different from the nominal color; and
the determining of the characteristic includes:
determining a parameter based on a difference between the first distance and the second distance, the first distance being greater than the second distance; and
determining the color for the virtual content based on the parameter by modifying a spectral property of the nominal color toward longer wavelengths based on the first distance being greater than the second distance.

5. The method of claim 1, wherein:
the virtual content is associated with a nominal color;
the characteristic is a color for the virtual content different from the nominal color; and
the determining of the characteristic includes:
determining a parameter based on a difference between the first distance and the second distance, the first distance being less than the second distance; and
determining the color for the virtual content based on the parameter by modifying a spectral property of the nominal color toward shorter wavelengths based on the first distance being less than the second distance.

6. The method of claim 1, wherein:
the characteristic is a color for the virtual content; and
the determining of the characteristic includes modifying a white point associated with the virtual content based on a parameter representing the first distance and the second distance.

7. The method of claim 1, wherein:
the surface is associated with an object in an environment in which the display device is operated;
the display device includes an eye tracking system configured to analyze an eye of a user of the display device; and
the determining of the characteristic is based on data generated by the eye tracking system to indicate that a gaze of the eye is directed to the surface of the object.

8. The method of claim 7, wherein the determining of the characteristic is based on a combination of:
the data generated by the eye tracking system to indicate that the gaze of the eye is directed to the surface of the object; and
additional data generated by a depth sensor configured to determine the second distance based on a pose of the display device within the environment with respect to the object.

9. The method of claim 7, wherein:
the eye tracking system is configured to analyze two eyes of the user; and
the determining of the characteristic includes:
determining, based on the data generated by the eye tracking system, a vergence angle of the two eyes of the user; and
determining the second distance based on the vergence angle.

10. The method of claim 1, wherein:
the characteristic is a color for the virtual content;
the display device includes a plurality of emitters including:
a first set of emitters configured to generate light of a first primary color, and
a second set of emitters configured to generate light of a second primary color different from the first primary color;
the determining of the characteristic for the virtual content includes omitting a contribution of the second primary color within the color for the virtual content; and
the displaying of the virtual content with the characteristic includes deactivating, based on the omitting of the contribution of the second primary color within the color, the second set of emitters.

11. The method of claim 1, wherein:
the characteristic is a color for the virtual content;
the virtual content includes monochrome text; and
the determining of the characteristic for the virtual content includes assigning a selected color to the monochrome text based on the first distance and the second distance.

12. The method of claim 1, further comprising monitoring for a change in the second distance from the display device to the surface visible in the region associated with the virtual content;
wherein the determining of the characteristic is performed in response to detecting the change in the second distance.

13. An apparatus comprising:
a plurality of emitters configured to generate light representing virtual content;
a waveguide configured to manipulate the light generated by the plurality of emitters to display the virtual content at a focal plane a first distance from the apparatus; and
a controller configured to:
determine a characteristic based on the first distance and based on a second distance from the apparatus to a surface visible in a region of a field of view associated with the virtual content; and
control the plurality of emitters to display the virtual content at the focal plane with the characteristic.

14. The apparatus of claim 13, wherein:
the surface is associated with an object in an environment in which the apparatus is operated;
the apparatus further comprises a depth sensor configured to determine the second distance based on a pose of the apparatus within the environment with respect to the object; and
the controller is further configured to determine the second distance using the depth sensor.

15. The apparatus of claim 13, wherein:
the apparatus is a monocular display device; and
the waveguide is configured to direct the light generated by the plurality of emitters to present the virtual content to one eye of a user.

16. The apparatus of claim 13, wherein the plurality of emitters includes a plurality of micro light emitting diodes (microLEDs) and the waveguide includes a diffractive waveguide.

17. The apparatus of claim 13, wherein:
the waveguide is configured to focus the focal plane at an infinite distance; and
based on operations performed by the controller, the apparatus displays the virtual content at the focal plane at the first distance without a push-pull lens system configured to adjust the focal plane from the infinite distance to the first distance.

18. A non-transitory computer-readable medium storing instructions that, when executed, cause a controller of a display device to perform a process comprising:
determining a characteristic for virtual content to be displayed by the display device within a field of view of the display device, the characteristic being determined based on:
a first distance from the display device to a focal plane for the virtual content, and
a second distance from the display device to a surface visible in a region of the field of view associated with the virtual content; and
causing the display device to display the virtual content at the focal plane with the characteristic.

19. The non-transitory computer-readable medium of claim 18, wherein:
the virtual content is associated with a nominal color;
the characteristic is a color for the virtual content different from the nominal color; and
the determining of the characteristic includes:
determining a parameter based on a difference between the first distance and the second distance, the first distance being greater than the second distance; and
determining the color for the virtual content based on the parameter by modifying a spectral property of the nominal color toward longer wavelengths based on the first distance being greater than the second distance.

20. The non-transitory computer-readable medium of claim 18, wherein:
the virtual content is associated with a nominal color;
the characteristic is a color for the virtual content different from the nominal color; and
the determining of the characteristic includes:
determining a parameter based on a difference between the first distance and the second distance, the first distance being less than the second distance; and
determining the color for the virtual content based on the parameter by modifying a spectral property of the nominal color toward shorter wavelengths based on the first distance being less than the second distance.
